(19) United States
(12) Patent Application Publication
(10) Pub. No.: US 2005/0198303 A1
(43) Pub. Date: Sep. 8, 2005

(54) Dynamic virtual machine service provider allocation

(76) Inventors: Robert Knauerhase, Portland, OR (US); Vijay Tewari, Portland, OR (US); Scott Robinson, Portland, OR (US); Mic Bowman, Beaverton, OR (US); Milan Milenkovic, Portland, OR (US)

Correspondence Address: MARGER, JOHNSON & MCCOLLOM, P.C. - INTEL, 1030 SW MORRISON ST., PORTLAND, OR, 97205, US

(21) Appl. No.: 10/754,098

(22) Filed: Jan. 2, 2004

(51) Int. Cl. G06F 15/16

(52) U.S. Cl. 709/227

(57) ABSTRACT

A server receives a request for a service. The server determines if a virtual machine already exists that offers the service. If so, the server returns an identifier of the virtual machine to the requesting client so that the client may access the service from the virtual machine. Otherwise, the server attempts to create an image of a virtual machine offering the service. If successful in creating the image, the image is installed as a new virtual machine in a host machine, and the server returns an identifier of the newly created virtual machine to the client.

### FIELD OF THE INVENTION

This invention pertains to networks, and more particularly to offering services over networks.

### BACKGROUND OF THE INVENTION

A network, which may include wired and/or wireless intranets, the Internet, wide area networks (WANs), local area networks (LANs), etc., may have many attached devices offering and/or seeking services, capabilities and/or resources of other devices. It is often difficult to locate devices offering particular services. To facilitate locating and tracking devices and their services, various “web service” or “directory service” technologies have been implemented.

The term “web service” describes a standardized way of describing, discovering, and integrating network applications, services and resources from different entities (e.g., businesses) using open standards, such as World Wide Web Consortium (W3C) and Internet Engineering Task Force (IETF) standards, including XML (Extensible Markup Language), SOAP (Simple Object Access Protocol), WSDL (Web Services Description Language), UDDI (Universal Description, Discovery and Integration), etc., over a network. Web services are self-contained modular applications that may communicate directly with other web services, applications, or system software.

UDDI is an industry initiative utilizing a platform-independent open framework for a global set of registries allowing businesses to define their services, discover other businesses and services, and to share information about how the business interacts.

But services as offered today, and the environments hosting them, suffer from their fixed-configuration nature, as well as from the difficulty and costs of administering services and servers in an environment where diverse clients want diverse services. Currently, to offer services, a service provider has to configure a server with the proper environment (which is often, for example, operating system and application software version-specific) and the services. This configuration is fixed: to offer other services requiring a different, incompatible hosting environment (e.g. different operating system or supporting environment software versions), the service provider has to configure another server with the other services.

The invention addresses these problems and others in the art.

### BRIEF DESCRIPTION OF THE DRAWINGS

FIG. 1 shows a server farm offering services across a network, according to an embodiment of the invention.

FIG. 2 shows details of the server of FIG. 1, according to an embodiment of the invention.

FIG. 3 shows components of the server of FIG. 1, according to an embodiment of the invention.

FIG. 4 shows a server state table stored in the server of FIG. 1, according to an embodiment of the invention.

FIGS. 5A-5D show a flowchart of the procedure for accessing a service using the server of FIG. 1, according to an embodiment of the invention.

### DETAILED DESCRIPTION OF THE PREFERRED EMBODIMENT

A service directory (or registry) facilitates advertising, discovering, and providing/using services and resources (collectively referred to as “registration”). Since resources may be encapsulated and advertised and used as services, unless indicated otherwise directly or by context, the term “services” is intended to include “resources.” In the illustrated embodiments, there may be many service directories on a network, where some service directories are kept fully synchronized (i.e. coherent) with other service directories, while other service directories may elect to keep some registrations private. Embodiments of the invention may be utilized with various directory services, web services, UDDI registries, .NET services by Microsoft Corporation, Universal Plug and Play (UPnP) services, Internet Distributed Computing (IDC) services, grid services (e.g., Open Grid Services Architecture (OGSA)) and resources, and the like. The terms “registry” and “service directory” are intended to generally reference these various service directory possibilities and equivalents thereto. While specific discussions may focus on UDDI service directories, a person skilled in the art will recognize that embodiments of the invention are also applicable to other service directories, and that as times change, alternate registries or services will arise, and that the teachings herein are applicable thereto.

A virtual machine (VM) may be an emulated machine or emulated platform in hardware (e.g., as a mode of operation of a processor), in firmware, or in software. The virtual machine may include the instruction set and other platform resources and/or devices. Virtual machines may be serialized (e.g. state checkpoint) to a shared file system or shipped over the network to be migrated to, de-serialized (e.g. state restore from checkpoint) on and hosted by a different machine. A single physical device may have (i.e. host) multiple virtual machines. Virtual machines may also utilize a virtual network in addition to, or in lieu of, a physical network connection.

Virtual machines typically operate in one of three states: active, sleeping, or archived. An active virtual machine is currently running in the processor of the host machine. A sleeping virtual machine is temporarily stopped (for example, the virtual machine might be waiting for I/O operations to complete) from running in the processor of the host machine, but may be returned to the processor as needed, typically by swapping the process, its memory, and related data to other memory. Often, a virtual machine is put to sleep to allow the processor to carry out some other function (e.g., to run another virtual machine, or some fundamental machine operation), but will be restored to active status eventually. Usually, sleeping virtual machines are in the process of providing some function or service, although frequently the sleeping virtual machine may be returned to active status even though there is no current request for the virtual machine. Finally, an archived virtual machine is one that has been more permanently swapped out of the processor and active memory, because the virtual machine has not been accessed for some period of time (this period of time is usually configurable). (An even more permanent state of removal is when the virtual machine is destroyed, but in that situation there is typically no way to restore the virtual machine to active status: the virtual machine must be re-instantiated.) The virtual machine manager is usually responsible for changing the state of the virtual machine.

Whether the virtual machines are active, sleeping, or archived, they exist in some storage on a machine. The storage may be any form of storage, be it memory, hard disk, magnetic media, optical media, or any other form of storage. Typically, active and sleeping virtual machines are stored in memory, whereas archived virtual machines are typically stored on a hard disk, but a person skilled in the art will recognize that the virtual machines may be stored on any desired storage.

As is understood in the art, the virtual machines operate in conjunction with a virtual machine manager. The virtual machine manager operates above the device hardware and regulates/arbitrates access by the virtual machines to the physical device hardware. Each machine hosting virtual machines includes a virtual machine manager. In some configurations, the virtual machine manager works in conjunction with the host operating system. In these cases, the virtual machine manager also regulates virtual machine access to the host operating system resources. The virtual machine manager may be configured to allow complete isolation of the virtual machines, or to allow data sharing between some or all of the virtual machines according to desired security policies. It will be appreciated that the virtual machine manager may be implemented in various ways, including in software, firmware, hardware, or a combination thereof on a host. For example, the virtual machine manager may be implemented as an application and device drivers, etc. (e.g. VMWare by VMware, Inc. of California), as part of the operating system, as a software or firmware layer between the operating system and bare hardware, or as part of a chipset or a microprocessor.

Rather than configuring individual machines to offer services in every viable combination, embodiments of the invention support services offered by virtual machines. The virtual machines may be created and deleted as needed, and may be installed on any available (or desired) machine. A given virtual machine may offer multiple services, and a given service may be offered by multiple virtual machines. Different virtual machines may offer different services. Different virtual machines may also offer otherwise identical services in different environments. For example, different virtual machines may offer services, where the only differences are the versions of the services, the security levels of the services, the particular implementations of the services, or the software environments (e.g. operating systems, libraries, managed runtime environments such as the Java platform by Sun Microsystems, Inc., or the Common Language Runtime by Microsoft Corporation, etc.) in which the services are offered. (Java is a trademark or registered trademark of Sun Microsystems, Inc. in the United States and other countries.) Thus, instead of having large numbers of machines, each offering a specific combination of operating systems, server software packages, and application services (the total number of combinations increases exponentially as the number of operating systems, server software packages, application services, and software environments increases), a small number of machines may be used, installed with specific virtual machines that implement the desired service(s) in a particular software environment. This reduces service hosting costs and improves hardware utilization. It can also offer security, isolation, fault tolerance, and load balancing benefits, among others.

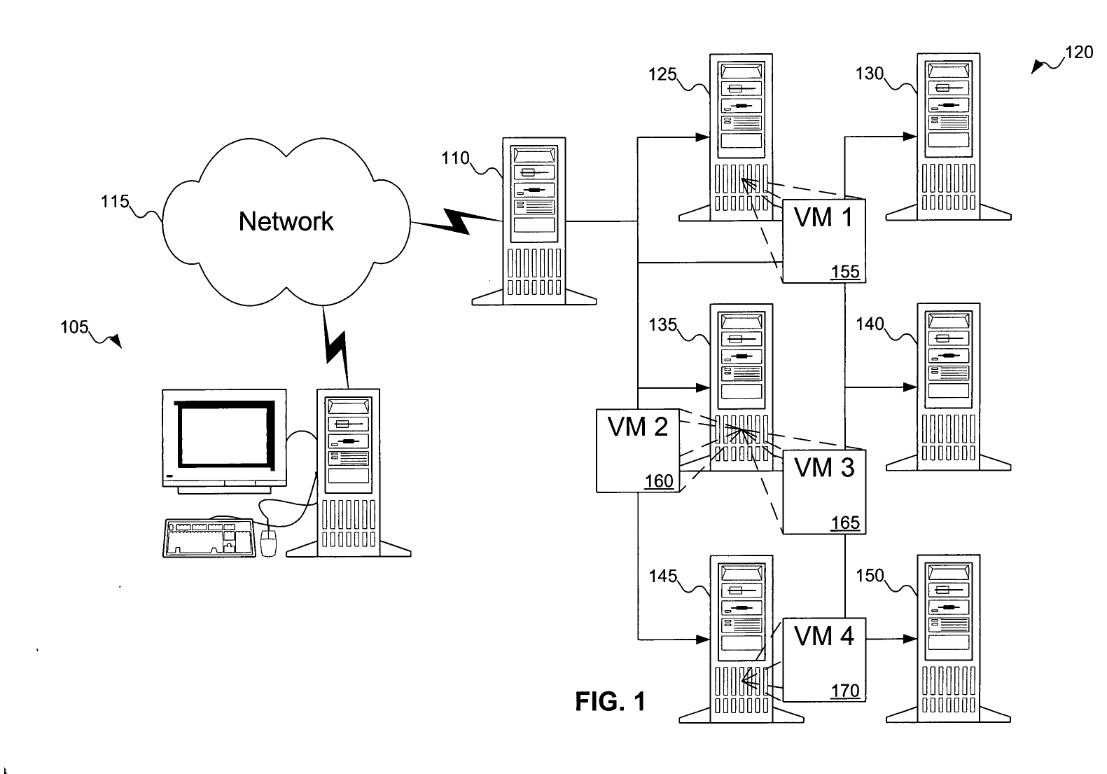

FIG. 1 shows a server farm offering services across a network, according to an embodiment of the invention. In FIG. 1, computer system 105 is a client, taking advantage of services offered via server 110. Computer system 105 is shown as including computer, monitor, keyboard, and mouse, but a person skilled in the art will recognize that computer system 105 may omit components shown and may include components not shown. For example, computer system 105 might omit mouse, and include a printer. In addition, the internal components of computer system 105 (e.g., microprocessor, memory, bus, etc.) are not shown in FIG. 1. A person skilled in the art will also recognize that computer system 105 may be another server, rather than a computer system accessed by end-users. Finally, a person skilled in the art will recognize that any of the computer systems (e.g., computer system 105 and server 110) may take other forms, such as sensors/motes, cellular phones, personal digital assistants (PDA) or other handheld devices, desktop personal computers, laptop computers, tablet personal computers, workstations, servers, mainframes.

Computer system 105 is coupled to computer 110 via network 115. Network 115 may be any variety of network. For example, network 115 may be an Ethernet (either IEEE 802.3 or Gigabit Ethernet) network, a wireless network utilizing Bluetooth or any of the IEEE 802.11a/b/g standards, or a cellular network, among others. (The Bluetooth standard may be found at “http:##www.bluetooth.com#dev#specifications.asp,” and the IEEE 802.11a-1999 (published in 1999), IEEE 802.11b-1999, IEEE 802.11b-1999/Cor1-2001 (published in 1999, corrected in 2001), and IEEE 802.11g-2003 (published in 2003) standards may be found online at “http:##standards.ieee.org#catalog#olis#lanman.html” (to avoid inadvertent hyperlinks, forward slashes (“/”) in the preceding uniform resource locators (URLs) have been replaced with pound signs (“#”)).

Server 110 is coupled to various other servers in server farm 120. In FIG. 1, server farm 120 includes servers 125, 130, 135, 140, 145, and 150, but a person skilled in the art will recognize that there may more or fewer than six servers (seven, if server 110 also hosts virtual machines) in server farm 120. Some of the servers in server farm 120 are shown currently supporting virtual machines. For example, server 125 is supporting virtual machine 155, server 135 is supporting virtual machines 160 and 165, and server 145 is supporting virtual machine 170.

As shown with server 135, a single server may support more than one virtual machine at a time, even though other servers in server farm 120 might appear to be available. The selection of which server within server farm 120 supports a particular virtual machine may be made based on any desired criteria. For example, the server may be chosen to balance the loads on the servers in server farm 120. (How load balancing is performed within server farm 120 is beyond the scope of this document.) Or, a cost model may be used to select the server to support the virtual machine, with some servers being more expensive than others. Thus, the same virtual machine image might be installed on multiple servers in server farm 120, to achieve the desired distribution of virtual machines. (Another reason to install the same virtual machine on multiple servers may be to provide some level of fault tolerance, so that if one server should happen to fail (or if the virtual machine should happen to fail, even if the server continues to operate normally), the service is still available on another virtual machine. Or, the server may be chosen to meet some security or isolation criterion for the virtual machine. Or, the server may be selected based on some priority of the customer: higher priority customers may utilize a faster server, a server with fewer installed virtual machines, or a server with virtual machines that are less frequently in active states. A person skilled in the art will recognize other models that may be used to determine which server will support a particular virtual machine. In addition, a person skilled in the art will recognize that virtual machines (either the image or a given, active instantiation) may be moved from one host machine to another, if such a relocation of the virtual machine is desired.

The above description introduces the term “image.” An “image” may be thought of as the virtual machine before it is activated. This may be contrasted with a sleeping virtual machine, which is temporarily inactive, but may eventually begin executing again. A useful analogy (albeit incomplete) is to software: until a program is executed, it is simply sitting on the medium. The unexecuted software is analogous to the image, the program as it is executing is analogous to the virtual machine.

In this document, references are made to both “virtual machines” and to “images.” As should be clear, these concepts are not identical, but they do overlap somewhat. Context should make it clear whether one or both of the terms “virtual machine” and “image” is intended. For example, discussion about changing the state of a virtual machine is not to be interpreted as including images, because images do not have a state. And discussion about serializing a virtual machine describes making an image out of a virtual machine. But discussion about copying a virtual machine is to be interpreted as including copying an image, because both may be copied.

Although FIG. 1 describes server farm 120 as being a set of servers each hosting virtual machines, with the virtual machines providing the services, services may be provided from real (i.e., physical, as opposed to virtual) machines within server farm 120. For example, server 140 may have installed services that are available for request, and not be capable of hosting any virtual machines. Or, server 145, in addition to hosting virtual machine 170, may also offer a service directly (i.e., a service offered from the native environment of server 145, that can be accessed without invoking a virtual machine). A person skilled in the art will recognize other possible combinations of real and virtual machines.

A person skilled in the art will recognize that servers in server farm 120 may include different hardware or software configurations, as desired. The only consideration pertinent to the selection servers 125-150 in server farm 120 is that the servers be capable of supporting virtual machines. As this is usually a question of software and not hardware, hardware choices are generally unconstrained, and any software environment capable of supporting virtual machines may be used.

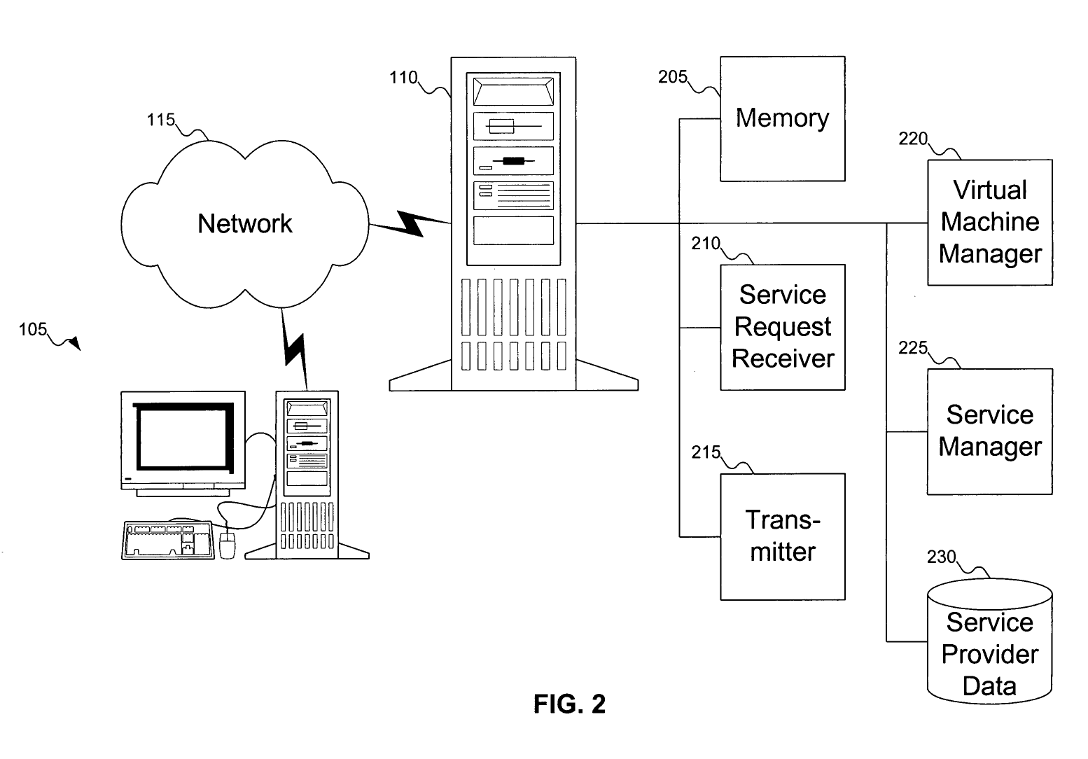

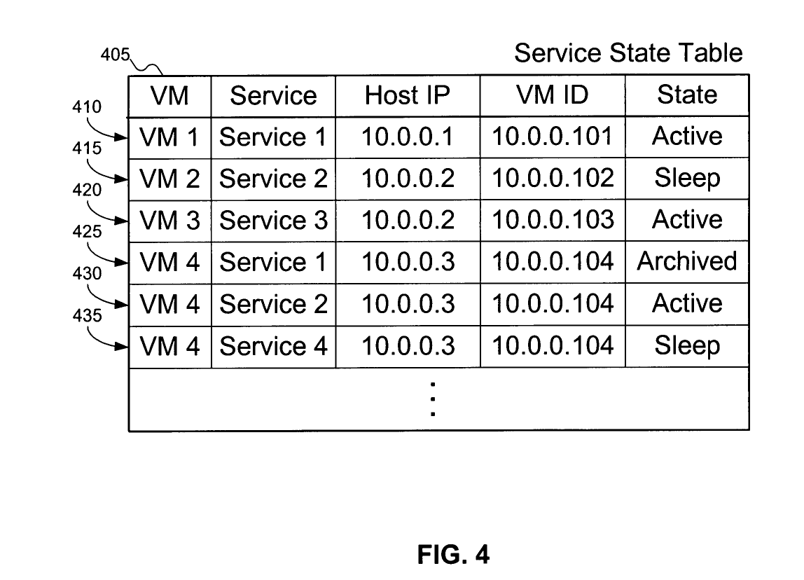

FIG. 2 shows details of the server of FIG. 1, according to an embodiment of the invention. Server 110 includes several components. Server 110 uses some of the components to determine which virtual machine offers a desired service. Memory 205 stores information about the various virtual machines operating within the server farm, such as which server is supporting which virtual machines, or the services offered by the virtual machines. A table showing such information is discussed further with reference to FIG. 4 below. Service request receiver 210 is responsible for receiving requests for services from devices connected via network 115, such as computer system 105. Transmitter 215 is responsible for transmitting to computer system 105 information about how to contact the virtual machine that provides the desired service. A person skilled in the art will recognize that service request receiver 210 and transmitter 215 may be combined in a single element.

Server 110 is also shown as including virtual machine manager 220. As described above, virtual machine manager 220 is responsible for implementing the virtual machine model on server 110. Since virtual machine manager 220 is responsible for the implementation of virtual machines in the host machine, the inclusion of virtual machine manager 220 in server 110 implies that server 110 is also capable of hosting virtual machines. If server 110 is used strictly to manage the services and does not host any virtual machines, virtual machine manager 220 may be omitted from server 110.

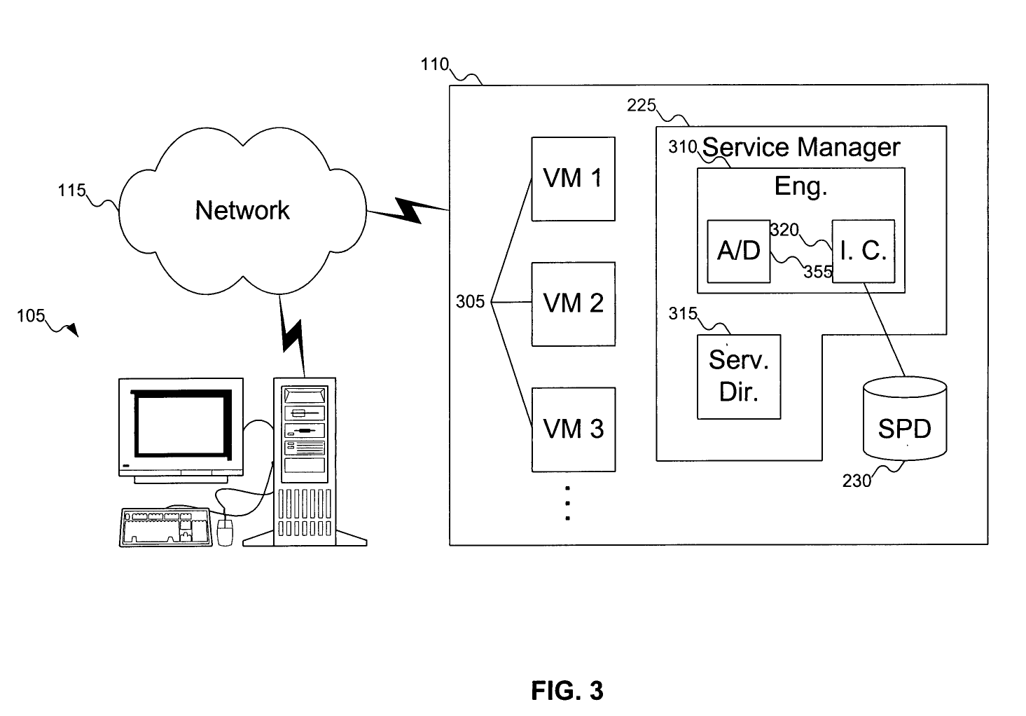

Server 110 uses other components to manage the virtual machines. Service manager 225 is responsible for instructing virtual machine manager 220 in the creation (and possibly destruction) of the virtual machines. Service manager 225 is discussed further with reference to FIG. 3 below. Service provider data 230 stores data used to dynamically create images of virtual machines as needed. For example, service provider data 230 may store various operating systems, server software, application software (which offers the services), patches (to operating systems, service providers, or application data), and any other data used to create images of service providers for virtual machines. Service provider data 230 may also store pre-constructed images (for example, images of commonly requested virtual machines), so that the pre-constructed images may be accessed rather than dynamically constructing the virtual machine image. The pre-constructed images may describe a virtual machine that needs to be “booted” (i.e., started for the “first” time), or may describe a virtual machine at a checkpoint (i.e., already started and at some known point in its execution). Using pre-constructed images may speed up the process of creating new virtual machine.

FIG. 3 shows components of the server of FIG. 1, according to an embodiment of the invention. In FIG. 3, server 110 is shown with three virtual machines 305. Although FIG. 3 shows server 110 as supporting the virtual machines directly, a person skilled in the art will recognize how to modify server 110 as shown in FIG. 3 to install images into servers in the server farm shown in FIG. 1.

As mentioned above, service manager 225 is responsible for creation of the virtual machines. Service manager 225 may be implemented in hardware, software, firmware, or any combination thereof. Service manager 225 keeps track of which virtual machine(s) are installed on which servers, and what combination of environment/application software is embodied by each virtual machine. To that end, service manager 225 may communicate with any server hosting a virtual machine offering a service. To enable these features service manager 225 includes engine 310 and service directory 315. Engine 310 is responsible for dynamically creating images of virtual machines, using image constructor 320. Image constructor 320 uses service provider data 230 (either the individual component data or the pre-constructed images) to build the images for new virtual machines, which may then be installed on a server to offer the desired service. For example, image constructor 320 may use service provider data 230 to create new images. Image constructor 320 may select an operating system, the server software, the application software, and any necessary patches to these elements, and use them to construct a new image of a virtual machine. Engine 310 may then select a machine into which the image may be installed. Once the new virtual machine is hosted, an identifier of the virtual machine (and service) may be returned to the client requesting the service, so that the client may access the service. If engine 310 is unable to create a virtual machine to offer the service, then service manager 225 indicates to the client that the requested service could not be provided.

If there is no virtual machine currently offering the requested service, and engine 310 has to create the virtual machine, some time will pass between the time the request is made and the time that service manager 225 responds to the request. If the amount of time required to create the image of the virtual machine, install it in a host machine, and return an identifier of the virtual machine to the client is too long (what qualifies as “too long” depends on the hardware/software environment and the desired service), service manager 225 may reply to the requesting client that no virtual machine is capable of supporting the service. This negative response may occur even though engine 310 is capable of creating a virtual machine offering the service. In one embodiment, engine 310 may continue to create the virtual machine, even though service manager 225 replies to the requesting client that the service is not available. The negative reply allows the requesting client to continue without undue delay, but the continued construction of the appropriate virtual machine means that future requests for that service may be satisfied. Negative responses may be distinguished into different flavors such as “will never be available” or “try again shortly.” These negative responses permit the client to proceed while giving more information about what next actions or recovery actions are required.

Engine 310 may also track the frequencies with which various services are requested. Engine 310 may add to the pre-constructed images in service provider data 230 any frequently requested images, so that virtual machines offering those services may be dynamically created more efficiently. Any desired criterion may be used to determine which services are requested frequently enough to qualify for addition to service provider data 230 as new pre-constructed images. Image constructor 320 may also start the virtual machine and bring it to a checkpoint before considering the image to be completely constructed. By bringing the virtual machine to a checkpoint before establishing the image, other virtual machines based on the image will not require as much time to start.

Because images may take up a large amount of storage, service manager 225 may implement policies to replace or evict images from service provider data 230. Service manager 225 may use policies similar to those used by other memory management systems, such as a cache. For example, service manager 225 may use a Least Recently Used replacement algorithm in selecting images for eviction. Service manager 225 may also use similar policies to replace or evict virtual machines from their hosts. For example, if service manager 225 is implemented so that it may manage a fixed number of virtual machines across the entire server farm, service manager 225 may use a policy, such as a Least Recently Used algorithm, to select a virtual machine for destruction.

Service manager 225 may take one of several forms. In one embodiment where the virtual machine manager is hosted by an operating system, service manager 225 is part of the operating system, or a driver. In a second embodiment, service manager 225 is integrated into the Basic Input/Output System (BIOS) of the computer. In a third embodiment, service manager 225 is built using federated virtual machine managers and/or management virtual machines. A “management virtual machine” is a special virtual machine that has privileges to communicate with the virtual machine manager. Typically, a management virtual machine can only communicate with the virtual machine manager on the server hosting the management virtual machine. The management virtual machine may provide some of the functionality normally associated with the virtual machine manager.

In a fourth embodiment, service manager 225 runs in a separate virtual machine. In a fifth embodiment, service manager 225 runs in a management virtual machine with special privileges and interfaces to the virtual machine managers. In one embodiment, the service manager communicates directly with the virtual machine managers on the various server farm machines. In a sixth embodiment, the service manager communicates with the various server farm machines through their management virtual machines.

Earlier, the virtual machine manager was described as being responsible for changing the state of or destroying virtual machines. In one embodiment, the virtual machine manager performs these functions under guidance from service manager 225. Service manager 225 typically has global knowledge about all of the virtual machines operative on any platform in the server farm, whereas the virtual machine manager is limited to information about the virtual machines on the individual server hosting the virtual machine manager. By letting service manager 225 be responsible for indicating changes of state of virtual machines, service manager 225 may utilize information not available to the virtual machine manager. For example, one virtual machine may be unused for some period of time, which would normally lead the virtual machine manager to archive (or perhaps destroy) the virtual machine. But if service manager 225 is aware that a service offered by the particular virtual machine, while currently underutilized, is frequently accessed, service manager 225 may instruct the virtual machine manager to leave the virtual machine in an active state. In another embodiment, service manager 225 performs these functions directly, essentially taking the place of the virtual machine manager.

To help service manager 225 keep its information current, the virtual machine manager may inform service manager 225 of changes of state in virtual machines managed by the virtual machine manager. State change information may be provided by the virtual machine manager automatically (for example, after every individual change of state or at certain intervals), or may be provided upon request by service manager 225.

If a virtual machine has been installed on a machine but has not been accessed for some period of time (as mentioned earlier, this period of time may be customizable), service manager 225 may archive the virtual machine. (Of course, if a request comes in for the service offered by the virtual machine, the virtual machine may be activated by returning it to the processor and active memory from the archive medium.) And if a virtual machine has been archived for a period of time (as with archival, the period of time used to decide whether to destroy a virtual machine is customizable), service manager 225 may delete the virtual machine entirely. Archiving may be done in varying degrees to leverage tradeoffs, such as speed to recovery versus storage space required. For example, a simple first step to archiving an image may be to simply store the image on hard disk. Next, the image may be compressed using standard compression algorithms, such as the Lempel-Ziv algorithm. Later, more radical, content-specific compression algorithms may be used, such as storing a list of the constituent components and a set of differences and specific configurations.

Service directory 315, as the name implies, is a directory of all services offered through server 110. For example, if server 110 is a UDDI server, service directory 315 identifies all remote procedure calls that may be made through server 110. Service directory 315 indicates the combinations of services offered through server 110. Because the services offered may vary not only based on the service itself, but also on the operating system or server software, and because the virtual machines may support different software environments, service directory 315 identifies not only the service offered but also the environments in which the service is offered.

In one embodiment, service directory 315 identifies all viable combinations of operating system, server software, application software, and patches. In this embodiment, service directory 315 may be used to immediately determine if a particular combination of application software and environment requested by a client may be implemented. If a particular combination is not listed in service directory 315, then the combination may not be created. In this embodiment, service directory 315 does not necessarily indicate which services are currently available (active, sleeping, or archived, as opposed to virtual machines that would need to be created): such information is typically stored elsewhere. But a person skilled in the art will recognize that service directory 315 may also store information about which services are currently available in this embodiment.

In another embodiment, service directory 315 identifies currently available services offered by installed virtual machines. In this embodiment, services directory 315 does not determine whether a request for a particular service may be satisfied by any creatable virtual machine; service directory 315 only lists which combinations of environment and service are currently available (active, sleeping, or archived). In this embodiment, engine 310 updates service directory 315 whenever a new virtual machine is created and when an existing virtual machine is deleted. Determining whether a request for a particular combination of service and environment may be satisfied (assuming no such combination exists in an available virtual machine) is the responsibility of engine 310.

In yet another embodiment, service directory 315 is not part of service manager 225, but rather is a separate element, potentially even stored on a different server. In this embodiment, service directory 315 needs to know all viable combinations of services and environments, because it is more difficult for service manager 225 to interact with services directory 315. In this embodiment, the operational sequence is typically as follows: the client requests a service and an environment from service directory 315. Service directory 315 verifies that the requested combination of service and environment is supportable, and requests that service manager 225 identify a machine offering such a service. Service manager 225 then creates or selects a virtual machine to offer the requested service, and returns an identifier of the virtual machine to service directory 315, which returns the identifier to the client.

Note that in this embodiment, service directory 315 might not even know that the services are offered with a virtual machine: the service directory might be expecting that service manager 225 is simply identifying a machine manually configured to offer the requested service. In other words, service directory 315 may be completely separated from the dynamic aspect of the service provision.

FIG. 4 shows a server state table stored in the server of FIG. 1, according to an embodiment of the invention. Server state table 405 shows several virtual machines, indicating the services the virtual machines offer, the machines on which the virtual machines are installed, identifiers for the virtual machines, and their current states. (Usually each virtual machine instantiation is assigned at least one network IP address, which can serve as the identifier.) For example, entry 410 shows that virtual machine 1 is active on the machine with Internet Protocol (IP) address 10.0.0.1, offering Service 1 (where Service 1 is a particular combination of an environment and a service), and is using the IP address of 10.0.0.101. Entries 415,420, and 425 show the states of other services. A person skilled in the art will recognize that the data shown in server state table 405 may be represented in other ways. For example, the host machines may be identified by machine name within the network, rather than by IP address. Or, the state information may be omitted and determined by querying the host machine for the current state of the virtual machine.

As FIG. 4 illustrates, note that multiple virtual machines can run on a given host and that multiple services can also run on a given virtual machine. Notice that both entries 415 and 420 are shown as being installed on the same machine (IP address 10.0.0.2). Similarly, entries 425, 430, and 435 demonstrate three services offered by virtual machine 4. As shown earlier in FIG. 1, a single server may support more than one installed virtual machine. Server state table 405 reflects this fact. Virtual machine 4 may distinguish among the three services represented by entries 425, 430, and 435 using any desired mechanism. For example, each service may be assigned to a different port. Or, the protocol used to request the service may uniquely identify the service. Or, the parameters provided in requesting the service may be used to identify the desired service. A person skilled in the art will recognize other ways in which multiple services on a single virtual machine may be distinguished.

Note that while embodiments of the invention may track virtual machine-to-host affinities, and therefore a server may be aware of what virtual machines exist in the server farm, clients of the services provided by these virtual machines are usually not aware that the service hosts are virtual. (But in some circumstances, the client may want to be aware as to whether or not the service is hosted by a virtual machine.) The client view is that there are a vast number of hosts of varying configurations offering services.

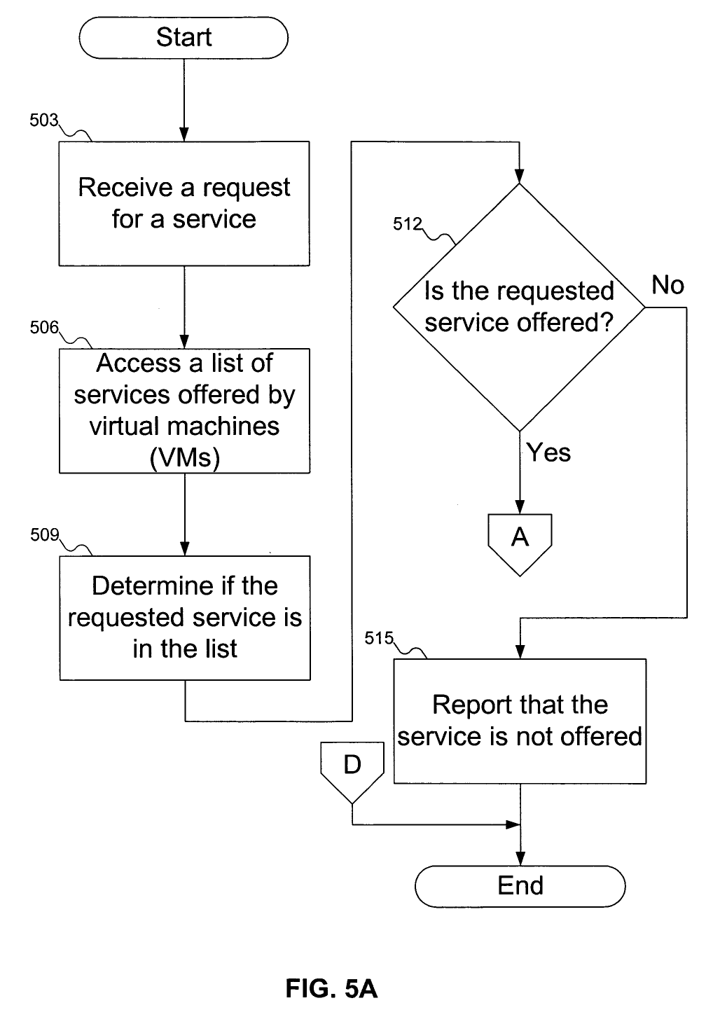

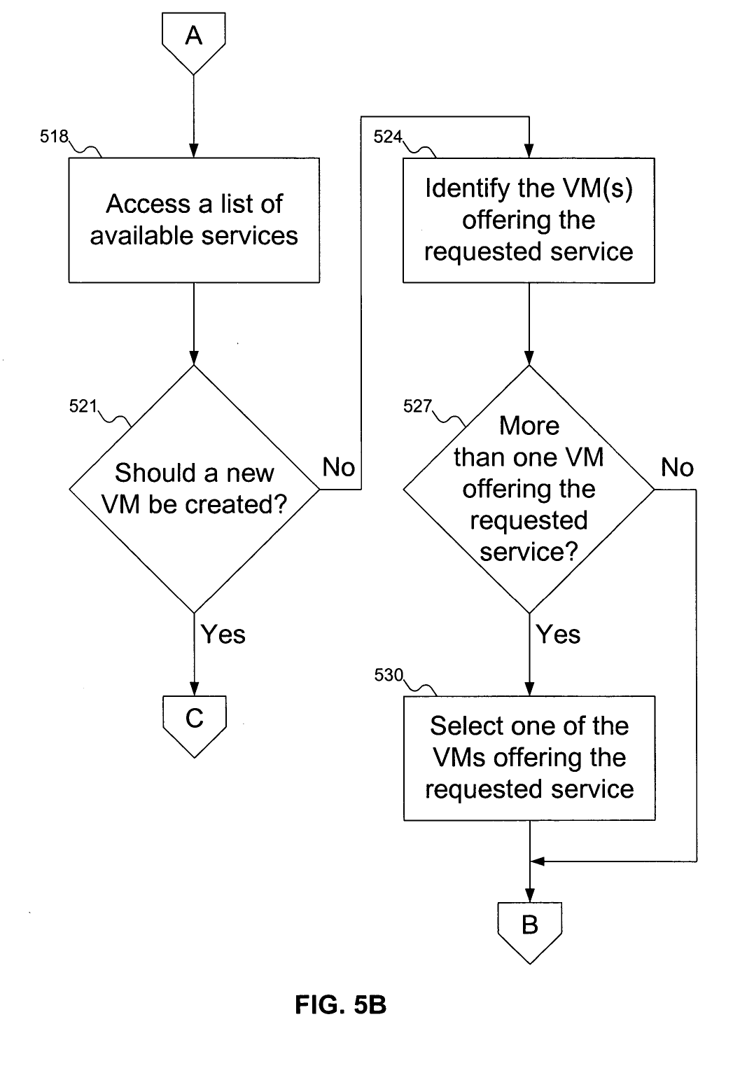

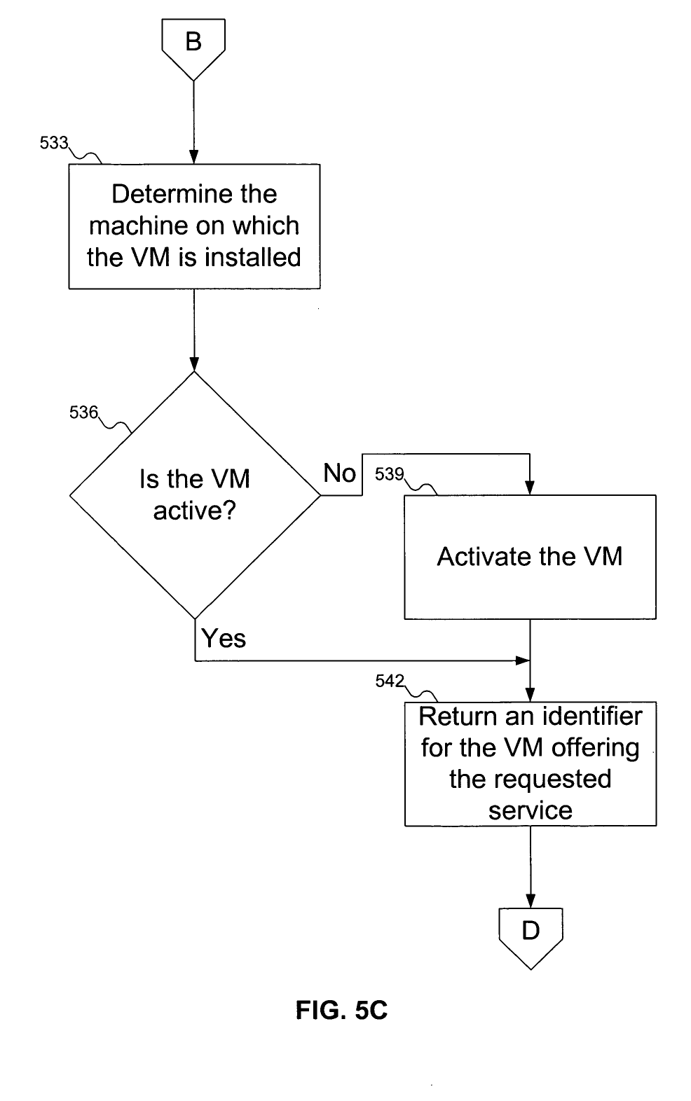

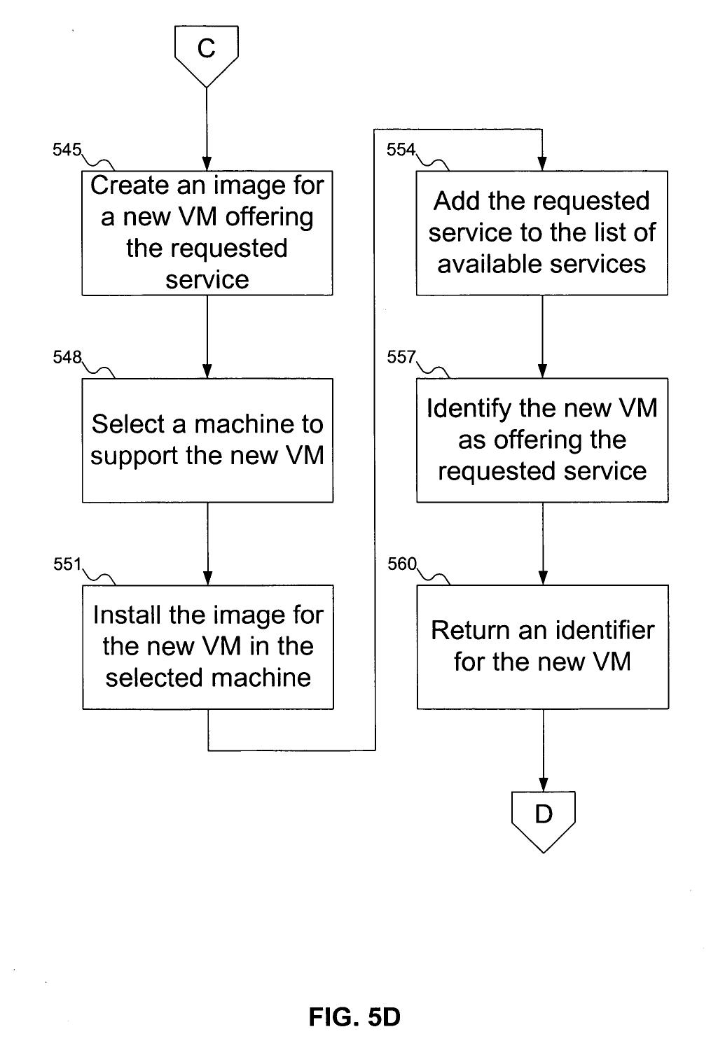

FIGS. 5A-5D show a flowchart of the procedure for accessing a service using the server of FIG. 1, according to an embodiment of the invention. In FIG. 5A, at block 503, a request for a service is received. At block 506, the server accesses a “list” of services that may be offered by virtual machines. (The concept of a “list” as shown in block 506 is an abstraction. As discussed above with reference to FIG. 3, service directory 315 may store all viable combinations of services and environments, or engine 310 may be used to determine if a particular combination is viable.) At block 509, the server determines if the requested service may be offered (i.e., the requested service is “in the list”). At decision point 512, the server switches, based on whether the requested service may be offered. If the requested service may not be offered, then at block 515, the server reports that the requested service may not be offered.

Otherwise, if the requested service may be offered by a virtual machine, then at block 518 (FIG. 5B) the server accesses a list of available services. At decision point 521, the server decides whether or not to create a new virtual machine. As described earlier with reference to FIG. 1, there are several reasons why a new virtual machine might be created, even though an existing virtual machine already offers the requested service. For example, the request might be for a service using a different cost model. Or, the server might create a new virtual machine offering the service to balance loads across machines hosting the virtual machines.

Returning to FIG. 5B, if the server is not creating a new virtual machine, then at block 524 the server identifies the virtual machine(s) offering the service. At block 527, the server checks to see if there is more than one virtual machine offering the requested service. If so, then at block 530 the server selects one of the virtual machines, using whatever internal decision model is desired (for example, to balance loads, or to minimize cost, or to provide the fastest response).

At block 533 (FIG. 5C), the server determines the machine hosting the selected virtual machine. At block 536, the server determines if the selected virtual machine is active. If not, then at block 539 the server activates the selected virtual machine. If the selected virtual machine was sleeping, then activation might not involve anything more than forwarding the request to the selected virtual machine. But if the selected virtual machine is archived, then activation might involve restoring the selected virtual machine from its archive medium and returning it to the memory of the host machine. At block 542, the server returns an identifier of the virtual machine to the client. (This identifier might be an IP address and service port identifier or name.)

If, at decision point 521, the server elected to create a new virtual machine, then at block 545 (FIG. 5D), the server creates a new image offering the requested service. At block 548, the server selects a machine to host the new virtual machine. At block 551, the image is installed in the host machine. At block 554, the requested service is added to the list of available services. At block 557, the server identifies the new virtual machine as offering the requested service, and updates the server state table. Finally, at block 560, the server returns an identifier of the virtual machine to the client.

Having described and illustrated the principles of the invention with reference to illustrated embodiments, it will be recognized that the illustrated embodiments may be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A service apparatus implemented in a machine, comprising:
a service request receiver to receive a request for a first service;
a storage;
a set of virtual machines stored in the storage, each virtual machine to implement a service;
a service manager to manage the set of virtual machines; and
a transmitter to return an access to a first virtual machine in the set of virtual machines as a response to the request for the first service.

2. A service apparatus according to claim 1, wherein:
the service apparatus further comprises:
a database of service provider data; and
an image constructor to use the database to construct an image; and
the service manager is operative to install the image as the first virtual machine in the set of virtual machines.

3. A service apparatus according to claim 1, wherein:
the service apparatus further comprises a database of images; and
the service manager is operative to install a first image from the database of images as the first virtual machine in the set of virtual machines.

4. A service apparatus according to claim 1, further comprising an archiver to archive the virtual machine.

5. A service apparatus according to claim 1, further comprising a deleter to delete the virtual machine.

6. A service apparatus according to claim 1, the service manager including a table stored in the storage, the table to indicate a state for each virtual machine in the set of virtual machines.

7. A service apparatus according to claim 1, further comprising a list of services offered by the service apparatus, the list of services to include at least the services offered by each virtual machine in the set of virtual machines.

8. A service apparatus according to claim 1, wherein at least one of the virtual machines implements the service and a second service.

9. A system, comprising:
a network;
a service request receiver to receive a request for a first service;
a list of services offered;
a service manager to manage a set of virtual machines; and
a transmitter to return an access to a first virtual machine in the set of virtual machines as a response to the request for the first service.

10. A system according to claim 9, further comprising a client machine coupled to the network, the client computer to send the request.

11. A system according to claim 9, further comprising at least one farm machine, each farm machine including:
a storage; and
at least one virtual machine from the set of virtual machines, stored in the storage of the farm machine, each virtual machine to implement a service.

12. A system according to claim 9, further comprising a list of services offered by the system, the list of services to include at least the services offered by each virtual machine in the set of virtual machines.

13. A system according to claim 9, further comprising a service apparatus, the service apparatus to include the service request receiver, the service manager, and the transmitter.

14. A system according to claim 9, further comprising:
a service apparatus, the service apparatus to include the service request receiver and the transmitter;
at least one farm machine, each farm machine to include:
a storage; and
at least one virtual machine from the set of virtual machines, stored in the storage of the farm machine, each virtual machine to implement a service; and
a management machine, the management machine to include the service manager.

15. A system according to claim 9, wherein at least one of the virtual machines in the set of virtual machines implements a first service and a second service.

16. A method, comprising:
receiving a request for a service;
accessing a list of services offered by a set of virtual machines;
determining if the requested service is in the list of services; and
if the requested service is in the list of services:
determining an identifier for the virtual machine offering the requested service; and
returning the identifier for the virtual machine offering the requested service.

17. A method according to claim 16, further comprising, if the requested service is not in the list of services:
creating an image for a new virtual machine that offers the requested service;
installing the image for the new virtual machine; and
returning an identifier for the new virtual machine.

18. A method according to claim 17, further comprising adding the requested service to the list of services.

19. A method according to claim 18, wherein adding the requested service includes identifying the new virtual machine in the list of services as offering the requested service.

20. A method according to claim 17, wherein installing the image includes:
selecting one of a set of machines to support the new virtual machine; and
installing the image for the new virtual machine in the selected machine.

21. A method according to claim 20, wherein selecting one of a set of machines includes selecting the selected machine to balance loads on the machines in the set of machines.

22. A method according to claim 17, wherein creating an image includes selecting a combination of software packages that define the new virtual machine to offer the requested service.

23. A method according to claim 17, wherein creating an image includes copying the image for the new virtual machine from a set of pre-constructed images.

24. A method according to claim 16, wherein:
determining the virtual machine offering the requested service includes:
determining that a new virtual machine should offer the requested service;
creating an image for the new virtual machine; and
installing the image for the new virtual machine;
returning an identifier for the virtual machine includes returning an identifier for the new virtual machine.

25. A method according to claim 16, wherein:
determining the virtual machine offering the requested service includes:
determining a plurality of virtual machines offering the requested service; and
selecting one of the plurality of virtual machines; and
returning an identifier for the virtual machine includes returning the identifier for the selected virtual machine.

26. A method according to claim 16, wherein determining the virtual machine includes:
determining if the virtual machine is active, sleeping, or archived; and
if the requested machine is sleeping or archived, activating the virtual machine.

27. An article, comprising:
a storage medium, said storage medium having stored thereon instructions, that, when executed by a machine, result in:
receiving a request for a service;
accessing a list of services offered by a set of virtual machines;
determining if the requested service is in the list of services; and
if the requested service is in the list of services:
determining the virtual machine offering the requested service; and
returning an identifier for the virtual machine offering the requested service.

28. An article according to claim 27, the storage medium further including instructions, that when executed by the machine, result in, if the requested service is not in the list of services:
creating an image for a new virtual machine that offers the requested service;
installing the image for the new virtual machine; and
returning an identifier for the new virtual machine.

29. An article according to claim 28, the storage medium further including instructions, that when executed by the machine, result in, adding the requested service to the list of services.

30. An article according to claim 29, wherein adding the requested service includes identifying the new virtual machine in the list of services as offering the requested service.

31. An article according to claim 28, wherein installing the image includes:
selecting one of a set of machines to support the new virtual machine; and
installing the image for the new virtual machine in the selected machine.

32. An article according to claim 31, wherein selecting one of a set of machines includes selecting the selected machine to balance loads on the machines in the set of machines.

33. An article according to claim 28, wherein creating an image includes selecting a combination of software packages that define the new virtual machine to offer the requested service.

34. An article according to claim 28, wherein creating an image includes copying the image for the new virtual machine from a set of pre-constructed images.

35. An article according to claim 27, wherein:
determining the virtual machine offering the requested service includes:
determining that a new virtual machine should offer the requested service;
creating an image for the new virtual machine; and
installing the image for the new virtual machine;
returning an identifier for the virtual machine includes returning an identifier for the new virtual machine.

36. An article according to claim 27, wherein:
determining the virtual machine offering the requested service includes:
determining a plurality of virtual machines offering the requested service; and
selecting one of the plurality of virtual machines; and
returning an identifier for the virtual machine includes returning the identifier for the selected virtual machine.

37. An article according to claim 27, wherein determining the virtual machine includes:
determining if the virtual machine is active, sleeping, or archived; and
if the requested machine is sleeping or archived, activating the virtual machine.
